(19) United States
(12) Patent Application Publication
(10) Pub. No.: US 2024/0012943 A1
(43) Pub. Date: Jan. 11, 2024

(54) SECURING ACCESS TO SECURITY SENSORS EXECUTING IN ENDPOINTS OF A VIRTUALIZED COMPUTING SYSTEM

(71) Applicant: VMWARE, INC., Palo Alto, CA (US)

(72) Inventors: SHIRISH VIJAYVARGIYA, Pune (IN); PANKAJ MAHESHKUMAR MANSUKHANI, Pune (IN); SUNIL HASBE, Pune (IN); SARJERAO PATIL, Pune (IN); SATYAJEET KUMAR, Pune (IN)

(21) Appl. No.: 17/938,985

(22) Filed: Sep. 7, 2022

(30) Foreign Application Priority Data
Jul. 8, 2022 (IN) 202241039353

(51) Int. Cl. G06F 21/64; G06F 21/62; G06F 21/60

(52) U.S. Cl. CPC G06F 21/64; G06F 21/6209; G06F 21/602

(57) ABSTRACT

An example method of securing communication between a client and a security agent executing in a host includes: receiving, at the security agent, a connection request from the client; obtaining, by the security agent from an operating system executing in the host, a process identifier for the client; identifying, by the security agent, a file path for a process binary from which the client executed; verifying at least a portion of the file path against an expected value known by the security agent; validating a signature of the process binary; and accepting, at the security agent, the connection request from the client in response to successful verification of the file path and successful validation of the signature.

### RELATED APPLICATIONS

Benefit is claimed under 35 U.S.C. 119(a)-(d) to Foreign Application Serial No. 202241039353 filed in India entitled “SECURING ACCESS TO SECURITY SENSORS EXECUTING IN ENDPOINTS OF A VIRTUALIZED COMPUTING SYSTEM”, on Jul. 8, 2022, by VMware, Inc., which is herein incorporated in its entirety by reference for all purposes,

Applications today are deployed onto a combination of virtual machines (VMs), containers, application services, physical servers without virtualization, and more within a software-defined datacenter (SDDC). The SDDC includes a server virtualization layer having clusters of physical servers that are virtualized and managed by virtualization management servers. Each host includes a virtualization layer (e.g., a hypervisor) that provides a software abstraction of a physical server (e.g., central processing unit (CPU), random access memory (RAM), storage, network interface card (NIC), etc.) to the VMs. A user, or automated software on behalf of an Infrastructure as a Service (IaaS), interacts with a virtualization management server to create server clusters (“host clusters”), add/remove servers (“hosts”) from host clusters, deploy/move/remove VMs on the hosts, deploy/configure networking and storage virtualized infrastructure, and the like. The virtualization management server sits on top of the server virtualization layer of the SDDC and treats host clusters as pools of compute capacity for use by applications.

A virtualized computing system can include an endpoint security platform for securing endpoints (e.g., VMs). An endpoint security platform can include security agents deployed in each endpoint (e.g., VM) that perform various security actions, such as antivirus/antimalware actions, device assessment and remediation actions, and the like. The security agents can be controlled by and managed through a backend security service. Each endpoint can include a utility installed therein that can be used to administer the security agent locally without the presence of the backend security service. Such a utility can be used for debugging, quality assurance testing, troubleshooting, and the like. While such local access by the utility is desirable, it is also desirable to prevent unauthorized access to the security sensor by potentially malicious applications.

### SUMMARY

In embodiments, a method of securing communication between a client and a security agent executing in a host includes: receiving, at the security agent, a connection request from the client; obtaining, by the security agent from an operating system executing in the host, a process identifier for the client; identifying, by the security agent, a file path for a process binary from which the client executed; verifying at least a portion of the file path against an expected value known by the security agent; validating a signature of the process binary; and accepting, at the security agent, the connection request from the client in response to successful verification of the file path and successful validation of the signature.

Further embodiments include a non-transitory computer-readable storage medium comprising instructions that cause a computer system to carry out the above methods, as well as a computer system configured to carry out the above methods.

### BRIEF DESCRIPTION OF THE DRAWINGS

FIG. 1 is a block diagram of a virtualized computing system in which embodiments described herein may be implemented.

FIG. 2 is a block diagram depicting logical communication between a client and a security agent in an endpoint according to embodiments.

FIG. 3 is a flow diagram depicting a method of securing access to a security agent according to embodiments.

### DETAILED DESCRIPTION

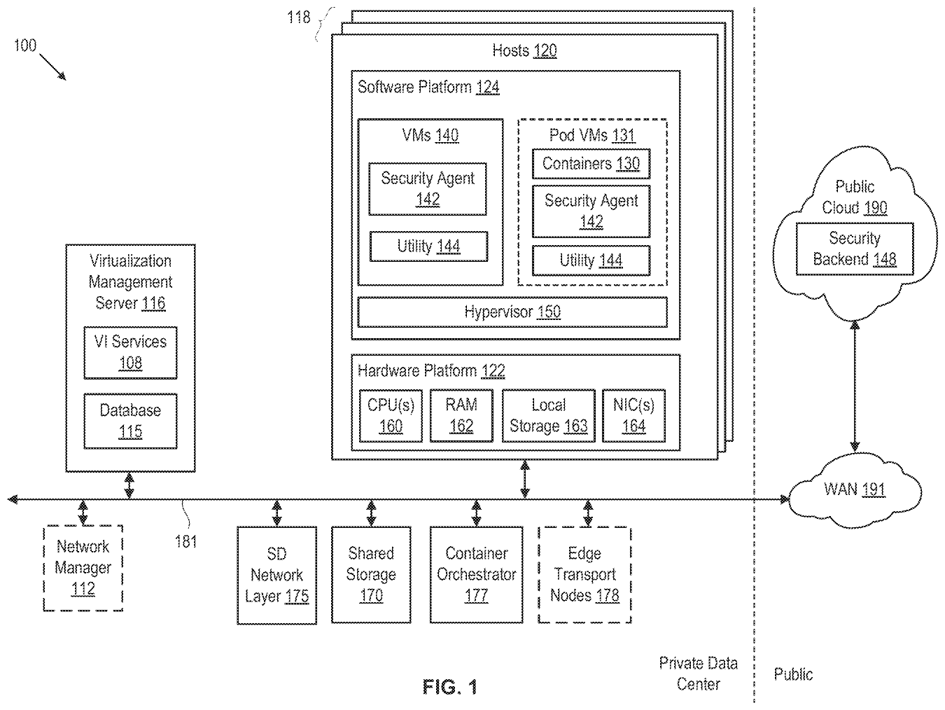

FIG. 1 is a block diagram of a virtualized computing system 100 in which embodiments described herein may be implemented. Virtualized computing system 100 can be a multi-cloud system having a private data center in communication with a public cloud 190. In embodiments, the private data center can be controlled and administered by a particular enterprise or business organization, while public cloud 190 is operated by a cloud computing service provider and exposed as a server available to account holders (“tenants”). The operator of the private data center can be a tenant of public cloud 190 along with a multitude of other tenants. The private data center is also known variously as an on-premises data center, on-premises cloud, or private cloud. The multi-cloud system is also known as a hybrid cloud system. In embodiments, virtualized computing system can be a single-cloud system, where the techniques described herein are performed in one cloud system (e.g., private data center or public cloud 190). Public cloud 190 can include infrastructure similar to that described below for the private data center.

The private data center is a software-defined data center (SDDC) that includes hosts 120. Hosts 120 may be constructed on server-grade hardware platforms such as an x86 architecture platforms. One or more groups of hosts 120 can be managed as clusters 118. As shown, a hardware platform 122 of each host 120 includes conventional components of a computing device, such as one or more central processing units (CPUs) 160, system memory (e.g., random access memory (RAM) 162), one or more network interface controllers (NICs) 164, and optionally local storage 163. CPUs 160 are configured to execute instructions, for example, executable instructions that perform one or more operations described herein, which may be stored in RAM 162. NICs 164 enable host 120 to communicate with other devices through a physical network 181. Physical network 181 enables communication between hosts 120 and between other components and hosts 120 (other components discussed further herein).

In the embodiment illustrated in FIG. 1, hosts 120 access shared storage 170 by using NICs 164 to connect to network 181. In another embodiment, each host 120 contains a host bus adapter (HBA) through which input/output operations (IOs) are sent to shared storage 170 over a separate network (e.g., a fibre channel (FC) network). Shared storage 170 include one or more storage arrays, such as a storage area network (SAN), network attached storage (NAS), or the like. Shared storage 170 may comprise magnetic disks, solid-state disks, flash memory, and the like as well as combinations thereof. In some embodiments, hosts 120 include local storage 163 (e.g., hard disk drives, solid-state drives, etc.). Local storage 163 in each host 120 can be aggregated and provisioned as part of a virtual SAN (vSAN), which is another form of shared storage 170.

A software platform 124 of each host 120 provides a virtualization layer, referred to herein as a hypervisor 150, which directly executes on hardware platform 122. In an embodiment, there is no intervening software, such as a host operating system (OS), between hypervisor 150 and hardware platform 122. Thus, hypervisor 150 is a Type-1 hypervisor (also known as a “bare-metal” hypervisor). As a result, the virtualization layer in host cluster 118 (collectively hypervisors 150) is a bare-metal virtualization layer executing directly on host hardware platforms. Hypervisor 150 abstracts processor, memory, storage, and network resources of hardware platform 122 to provide a virtual machine execution space within which multiple virtual machines (VM) 140 may be concurrently instantiated and executed. One example of hypervisor 150 that may be configured and used in embodiments described herein is a VMware ESXi™ hypervisor provided as part of the VMware vSphere® solution made commercially available by VMware, Inc. of Palo Alto, CA.

Virtualized computing system 100 is configured with a software-defined (SD) network layer 175. SD network layer 175 includes logical network services executing on virtualized infrastructure of hosts 120. The virtualized infrastructure that supports the logical network services includes hypervisor-based components, such as resource pools, distributed switches, distributed switch port groups and uplinks, etc., as well as VM-based components, such as router control VMs, load balancer VMs, edge service VMs, etc. Logical network services include logical switches and logical routers, as well as logical firewalls, logical virtual private networks (VPNs), logical load balancers, and the like, implemented on top of the virtualized infrastructure. In embodiments, virtualized computing system 100 includes edge transport nodes 178 that provide an interface of host cluster 118 to a wide area network (WAN) 191 (e.g., a corporate network, the public Internet, etc.). Edge transport nodes 178 can include a gateway (e.g., implemented by a router) between the internal logical networking of host cluster 118 and the external network. The private data center can interface with public cloud 190 through edge transport nodes 178 and WAN 191, Edge transport nodes 178 can be physical servers or VMs. Virtualized computing system 100 also includes physical network devices (e.g., physical routers/switches) as part of physical network 181, which are not explicitly shown.

Virtualization management server 116 is a physical or virtual server that manages hosts 120 and the hypervisors therein. Virtualization management server 116 installs agent(s) in hypervisor 150 to add a host 120 as a managed entity. Virtualization management server 116 can logically group hosts 120 into host cluster 118 to provide cluster-level functions to hosts 120, such as VM migration between hosts 120 (e.g., for load balancing), distributed power management, dynamic VM placement according to affinity and anti-affinity rules, and high-availability. The number of hosts 120 in host cluster 118 may be one or many. Virtualization management server 116 can manage more than one host cluster 118. While only one virtualization management server 116 is shown, virtualized computing system 100 can include multiple virtualization management servers each managing one or more host clusters.

In an embodiment, virtualized computing system 100 further includes a network manager 112. Network manager 112 is a physical or virtual server that orchestrates SD network layer 175. In an embodiment, network manager 112 comprises one or more virtual servers deployed as VMs. Network manager 112 installs additional agents in hypervisor 150 to add a host 120 as a managed entity, referred to as a transport node. One example of an SD networking platform that can be configured and used in embodiments described herein as network manager 112 and SD network layer 175 is a VMware NSX® platform made commercially available by VMware, Inc. of Palo Alto, CA. In other embodiments, SD network layer 175 is orchestrated and managed by virtualization management server 116 without the presence of network manager 112.

Virtualization management server 116 can include various virtual infrastructure (VI) services 108. VI services 108 can include various services, such as a management daemon, distributed resource scheduler (DRS), high-availability (HA) service, single sign-on (SSO) service, and the like. VI services 108 persist data in a database 115, which stores an inventory of objects, such as clusters, hosts, VMs, resource pools, datastores, and the like. Users interact with VI services 108 through user interfaces, application programming interfaces (APIs), and the like to issue commands, such as forming a host cluster 118, configuring resource pools, define resource allocation policies, configure storage and networking, and the like.

In embodiments, services can also execute in containers 130. In embodiments, hypervisor 150 can support containers 130 executing directly thereon. In other embodiments, containers 130 are deployed in VMs 140 or in specialized VMs referred to as “pod VMs 131.” A pod VM 131 is a VM that includes a kernel and container engine that supports execution of containers, as well as an agent (referred to as a pod VM agent) that cooperates with a controller executing in hypervisor 150. In embodiments, virtualized computing system 100 can include a container orchestrator 177. Container orchestrator 177 implements an orchestration control plane, such as Kubernetes®, to deploy and manage applications or services thereof in pods on hosts 120 using containers 130. Container orchestrator 177 can include one or more master servers configured to command and configure controllers in hypervisors 150. Master server(s) can be physical computers attached to network 181 or implemented by VMs 140/131 in a host cluster 118.

In embodiments, the virtual computing instances (e.g., VMs 140 and pod VMs 131) each include a security agent 142 and a utility 144. Security agent 142 is configured to cooperate with a security backend 148 to perform various security functions, such as virus/malware detection and prevention, software auditing and remediation, and the like. Utility 144 is configured to allow a user local access to security agent 142 (rather than through security backend 148). Utility 144 can be used, for example, when security backend 148 is not present. Utility 144 can be used for debugging, automated testing, troubleshooting and repairing, validating security policy/rules, local administration, and the like.

In embodiments, utility 144 can control the behavior of security agent 142. For example, a user can access security agent 142 through utility 144 to put the endpoint (e.g., VM 131/140) into a quarantine state/disabled state. Utility 144 can also be used to change a process/application ban list, company approved list, security policy, or the like. Since utility 144 can be used to alter the behavior of security agent 142, the local access to security agent 142 should be secure. Otherwise, the security of the endpoint can be compromised by an unauthorized application accessing security agent 142.

One technique for securing utility 144 and local access to security agent 142 is to use a code that utility supplies to security agent 142. The code can he obtained from security backend 148. Security agent 142 is configured with knowledge of the code (e.g., in a configuration file) and validates the code before allowing local access to utility 144 (or any application requesting local access). However, there are some disadvantages to such a technique. The user of utility 144 must obtain the code from security backend 148, requiring the user to have access to both security backend 148 and the endpoint. Since some functions of utility 144 are useful without the presence of security backend 148, this code validation technique can be counterproductive. Further, if one code is used for all endpoints in the data center, there is a security risk that the code can leak and be used by unauthorized applications to obtain local access to security agent 142. If a different code is used for each endpoint, there is significant administrative overhead to maintain many different codes. Further, it is possible that the utility 144 itself is compromised and can control the behavior of security agent 142 in an unauthorized fashion once obtaining the code. If the code is distributed in plaintext, a malicious application can intercept and use the code to obtain local access to security agent 142.

In embodiments, security agent 142 is configured to validate the integrity of utility 144 before processing any requests from utility 144. First, security agent 142 executes connection source validation. In embodiments, utility 144 and security agent 142 communicate using a Unix Domain Socket (UDS). In such case, security agent 142 uses a getsockopt( )system function to obtain the user identifier (UID), group identifier (GM), and/or process identifier (PID) of the client requesting access. Security agent 142 uses the PID to check a symbolic link of the process binary, e.g., /proc/<PID>/exe” symbolic link. This symbolic link points to the binary file executed to spawn the process having PID. Security agent 142 then verifies whether the symbolic link includes the expected filename for the process binary of utility 144. Security agent 142 refuses connection of any client not having the expected filename in its process binary. The technique for obtaining the process binary filename has been described with respect to a Linux®-based operating system, For other operating systems, security agent 142 can use similar techniques to obtain a process identifier and a corresponding filename of the process binary.

Second, security agent 142 executes process binary integrity validation. After determining the filename and path of the process binary using the connection source validation as described above, security agent 142 validates a signature of the process binary. In embodiments, security agent 142 is configured with a public key. Security agent 142 uses the public key to check the signature of the process binary that has been signed using a private key paired with the public key. For a compromised process binary, the signature will not match an expected signature. In case of signature mismatch, security agent 142 refuses the connection.

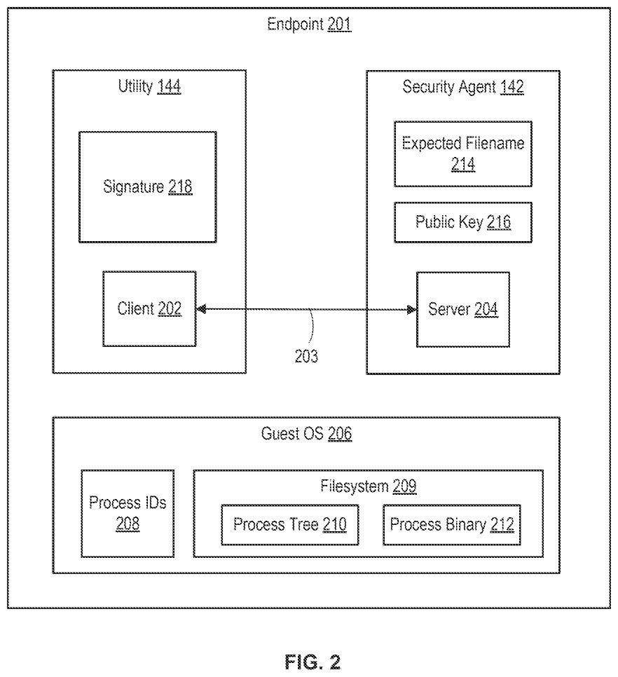

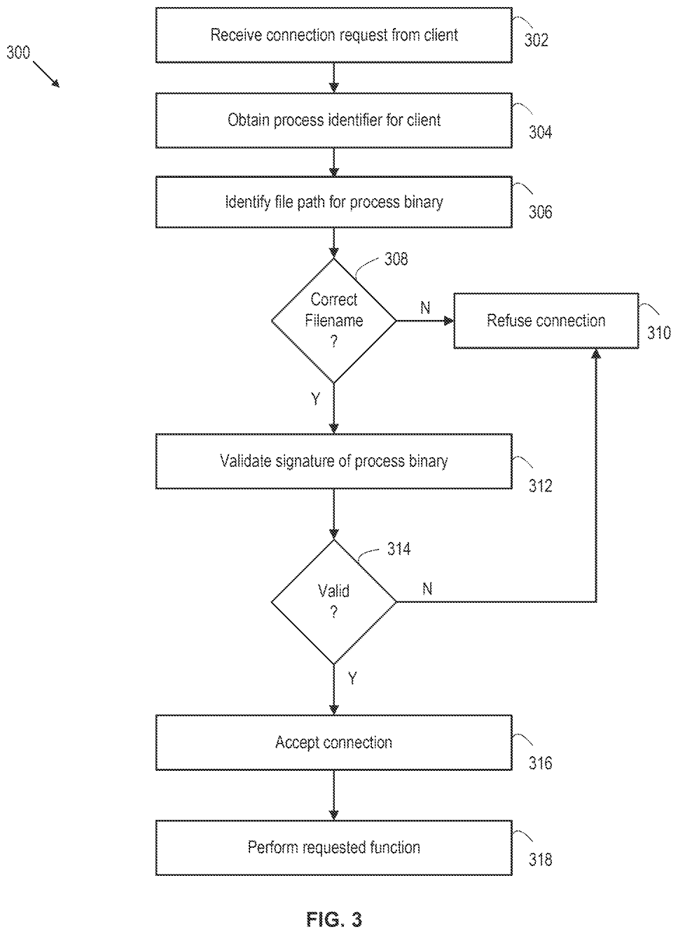

FIG. 2 is a block diagram depicting logical communication between a client and a security agent in an endpoint according to embodiments. FIG. 3 is a flow diagram depicting a method 300 of securing access to a security agent according to embodiments. Referring to FIGS. 2-3, endpoint 201 comprises a VM 140, pod VM 131, or any virtual computing instance in a host 120. Utility 144 includes a client 202 and security agent 142 includes a server 204. Client 202 requests a connection to server 204 in order to control the behavior of security agent 142 is some way. Utility 144 and security agent 142 execute on a guest operating system (OS) 206 of endpoint 201 (e.g., Linux).

Method 300 begins at step 302, where security agent 142 (e.g., via server 204) receives a connection request from a client (e.g., client 202 of utility 144). Server 204 can be a thread of the security agent process 142, and client 202 can be a thread of the utility process. At step 304, security agent 142 obtains a process identifier (PID) for the client. In embodiments, guest OS 206 maintains a list of process IDs 208 for the executing processes. Security agent 142 can call a system function of guest OS 206 to obtain the PID of the client making the request based on a connection 203 between client 202 and server 204. In embodiments, connection 203 is a LDS connection and security agent 142 can call getsockopt( ) to obtain the PID of the client. Those skilled in the art will appreciate that other techniques can be used to obtain the PID of the client based on the type of guest operating system.

At step 306, security agent 142 identifies a file path in a filesystem 209 of a process binary 212 for the client (e.g., utility 144 and client 202). In embodiments, security agent 142 can parse a process tree 210 using the PID of the client to obtain the file path of process binary 212, Those skilled in the art will appreciate that other techniques can be used to obtain the file path of process binary 212 depending on the type of the guest OS.

At step 308, security agent 142 determines whether the filename of the process binary matches an expected filename 214. In another embodiment, security agent 142 can determine whether the file path of the process binary matches an expected file path. In either case, if not, method 300 proceeds to step 310, where security agent 142 refuses the connection with the client. If the filename or file path is correct, method 300 proceeds to step 312.

At step 312, security agent 142 validates a signature 218 of process binary 212. In embodiments, security agent 142 uses a public key 216 that is paired with a private key used to generate signature 218 to validate signature 218. Any type of asymmetric cryptography technique can be used to generate signature 218 and to validate signature 218 using the private/public key pair. At step 314, security agent 142 determines if signature 218 is valid. If not, method 300 proceeds to step 310, where security agent 142 refuses the connection with the client. If signature 218 is valid, method 300 proceeds to step 316.

At step 316, security agent 142 accepts the connection with the client. At step 318, security agent 142 performs the requested function. Requested functions can include, for example, status, enable/disable bypass mode, version information, help information, enable/disable debug mode, capture diagnostics, and the like.

One or more embodiments of the invention also relate to a device or an apparatus for performing these operations. The apparatus may be specially constructed for required purposes, or the apparatus may be a general-purpose computer selectively activated or configured by a computer program stored in the computer. Various general-purpose machines may be used with computer programs written in accordance with the teachings herein, or it may be more convenient to construct a more specialized apparatus to perform the required operations.

The embodiments described herein may be practiced with other computer system configurations including hand-held devices, microprocessor systems, microprocessor-based or programmable consumer electronics, minicomputers, mainframe computers, etc.

One or more embodiments of the present invention may be implemented as one or more computer programs or as one or more computer program modules embodied in computer readable media. The term computer readable medium refers to any data storage device that can store data which can thereafter be input to a computer system. Computer readable media may be based on any existing or subsequently developed technology that embodies computer programs in a manner that enables a computer to read the programs. Examples of computer readable media are hard drives, NAS systems, read-only memory (ROM), RAM, compact disks (CDs), digital versatile disks (DVDs), magnetic tapes, and other optical and non-optical data storage devices. A computer readable medium can also be distributed over a network-coupled computer system so that the computer readable code is stored and executed in a distributed fashion.

Although one or more embodiments of the present invention have been described in some detail for clarity of understanding, certain changes may be made within the scope of the claims. Accordingly, the described embodiments are to be considered as illustrative and not restrictive, and the scope of the claims is not to be limited to details given herein but may be modified within the scope and equivalents of the claims. In the claims, elements and/or steps do not imply any particular order of operation unless explicitly stated in the claims.

Virtualization systems in accordance with the various embodiments may be implemented as hosted embodiments, non-hosted embodiments, or as embodiments that blur distinctions between the two. Furthermore, various virtualization operations may be wholly or partially implemented in hardware. For example, a hardware implementation may employ a look-up table for modification of storage access requests to secure non-disk data.

Many variations, additions, and improvements are possible, regardless of the degree of virtualization. The virtualization software can therefore include components of a host, console, or guest OS that perform virtualization functions.

Plural instances may be provided for components, operations, or structures described herein as a single instance. Boundaries between components, operations, and data stores are somewhat arbitrary, and particular operations are illustrated in the context of specific illustrative configurations. Other allocations of functionality are envisioned and may fall within the scope of the invention. In general, structures and functionalities presented as separate components in exemplary configurations may be implemented as a combined structure or component. Similarly, structures and functionalities presented as a single component may be implemented as separate components. These and other variations, additions, and improvements may fall within the scope of the appended claims.

What is claimed is:

1. A method of securing communication between a client and a security agent executing in a host, comprising:
receiving, at the security agent, a connection request from the client;
obtaining, by the security agent from an operating system executing in the host, a process identifier for the client;
identifying, by the security agent, a file path for a process binary from which the client executed;
verifying at least a portion of the file path against an expected value known by the security agent;
validating a signature of the process binary; and
accepting, at the security agent, the connection request from the client in response to successful verification of the file path and successful validation of the signature.

2. The method of claim 1, wherein the security agent and the client execute in a virtual computing instance managed by a hypervisor executing in the host, and wherein the operating system is a guest operating system executing in the virtual computing instance.

3. The method of claim 1, wherein the security agent obtains the process identifier of the client using a system function of the operating system that returns options related to a connection established between the security agent and the client.

4. The method of claim 1, wherein the security agent identifies the file path for the process binary by parsing, using the process identifier, a process tree maintained by the operating system in a file system.

5. The method of claim 1, wherein the at least a portion of the file path comprises at least a file name of the process binary.

6. The method of claim 1, wherein the security agent validates the signature of the process binary using a public key where the signature is generated using a private key paired with the public key.

7. The method of claim 1, further comprising:
performing, in response to accepting the connection request, a function requested by the client at the security agent.

8. A non-transitory computer readable medium comprising instructions to be executed in a computing device to cause the computing device to carry out a method of securing communication between a client and a security agent executing in a host, comprising:
receiving, at the security agent, a connection request from the client;
obtaining, by the security agent from an operating system executing in the host, a process identifier for the client;
identifying, by the security agent, a file path for a process binary from which the client executed;
verifying at least a portion of the file path against an expected value known by the security agent;
validating a signature of the process binary; and
accepting, at the security agent, the connection request from the client in response to successful verification of the file path and successful validation of the signature.

9. The non-transitory computer readable medium of claim 8, wherein the security agent and the client execute in a virtual computing instance managed by a hypervisor executing in the host, and wherein the operating system is a guest operating system executing in the virtual computing instance.

10. The non-transitory computer readable medium of claim 8, wherein the security agent obtains the process identifier of the client using a system function of the operating system that returns options related to a connection established between the security agent and the client.

11. The non-transitory computer readable medium of claim 8, wherein the security agent identifies the file path for the process binary by parsing, using the process identifier, a process tree maintained by the operating system in a file system.

12. The non-transitory computer readable medium of claim 8, wherein the at least a portion of the file path comprises at least a file name of the process binary.

13. The non-transitory computer readable medium of claim 8, wherein the security agent validates the signature of the process binary using a public key where the signature is generated using a private key paired with the public key.

14. The non-transitory computer readable medium of claim 8, further comprising:
performing, in response to accepting the connection request, a function requested by the client at the security agent.

15. A virtualized computing system, comprising:
a hardware platform;
software, executing on the hardware platform, including a client in communication with a security agent, the software:
receiving, at the security agent, a connection request from the client;
obtaining, by the security agent from an operating system, a process identifier for the client;
identifying, by the security agent, a file path for a process binary from which the client executed;
verifying at least a portion of the file path against an expected value known by the security agent;
validating a signature of the process binary; and
accepting, at the security agent, the connection request from the client in response to successful verification of the file path and successful validation of the signature.

16. The virtualized computing system of claim 15, wherein the security agent and the client execute in a virtual computing instance managed by a hypervisor executing on the hardware platform, and wherein the operating system is a guest operating system executing in the virtual computing instance.

17. The virtualized computing system of claim 15, wherein the security agent obtains the process identifier of the client using a system function of the operating system that returns options related to a connection established between the security agent and the client.

18. The virtualized computing system of claim 15, wherein the security agent identifies the file path for the process binary by parsing, using the process identifier, a process tree maintained by the operating system in a file system.

19. The virtualized computing system of claim 15, wherein the security agent validates the signature of the process binary using a public key where the signature is generated using a private key paired with the public key.

20. The virtualized computing system of claim 15, wherein the software is configured to:
perform, in response to accepting the connection request, a function requested by the client at the security agent.
